(19) United States
(12) Patent Application Publication
(10) Pub. No.: US 2025/0149019 A1
(43) Pub. Date: May 8, 2025

(54) METHOD FOR SPEECH GENERATION AND RELATED DEVICE

(71) Applicant: HUAWEI TECHNOLOGIES CO., LTD., Shenzhen (CN)

(72) Inventors: Sadekov TASNIMA, Moscow (RU); Vadim POPOV, Moscow (RU); Gogoryan VLADIMIR, Moscow (RU); Kudinov MIKHAIL, Moscow (RU)

(21) Appl. No.: 19/020,264

(22) Filed: Jan. 14, 2025

Related U.S. Application Data
(63) Continuation of application No. PCT/CN2023/094275, filed on May 15, 2023.

(30) Foreign Application Priority Data
Jul. 15, 2022 (RU) 2022119398

(51) Int. Cl. G10L 13/02; G10L 21/12; G10L 25/30

(52) U.S. Cl. CPC G10L 13/02; G10L 21/12; G10L 25/30

(57) ABSTRACT

Embodiments of the present application provide a method for speech generation and a related device, the method includes: obtaining a first source data input to a speech generation model including multiple encoders and a decoder, where types of input data of the multiple encoders are different; generating a first acoustic feature by a first encoder among the multiple encoders based on the first source data; and converting a second acoustic feature determined from the first acoustic feature into a third acoustic feature by the decoder. The above technical solution can rely on a single model to perform different speech generation tasks.

### CROSS-REFERENCE TO RELATED APPLICATIONS

This application is a continuation of International Application No. PCT/CN2023/094275, filed on May 15, 2023, which claims priority to Russia Patent Application No. RU2022119398, filed on Jul. 15, 2022. The disclosures of the aforementioned applications are hereby incorporated by reference in their entireties.

### TECHNICAL FIELD

Embodiments of the present disclosure relate to the field of speech technologies, and more specifically, to a method for speech generation and a related device.

### BACKGROUND

Speech generation is a technology of generating speech from an input. Speech generation can refer to all kinds of speech generation like text-to-speech (TTS), voice conversion, video-to-speech, or the like. Different speech generation tasks are usually solved by different frameworks, which limits application of the speech generation in practice. For example, in some scenarios, there are limited resource for the speech generation on the electronic device. However, different frameworks may require a lot of resources, such as storage resources and computing resources, even more than limited resources, which affects the application of the speech generation.

### SUMMARY

Embodiments of the present application provide a method for speech generation and a related device. A technical solution can rely on a single model to perform different speech generation tasks.

According to a first aspect, an embodiment of the present application provides a method for speech generation, including: obtaining a first source data input to a speech generation model including multiple encoders and a decoder, where types of input data of the multiple encoders are different; generating a first acoustic feature by a first encoder among the multiple encoders based on the first source data, where the type of the first source data is consistent with the type of the input data of the first encoder; and converting a second acoustic feature determined from the first acoustic feature into a third acoustic feature by the decoder, where the third acoustic feature is configured to generate a speech with a target voice.

The speech generation model in the embodiments of the present application has the multiple encoders and a shared decoder, in which the multiple encoders can operate on different input domains, respectively, so that a whole model performs corresponding different speech generation tasks. In other word, solutions of the embodiments of the present application can generate a speech based on different types of input data with one model.

In an embodiment, the decoder is a diffusion-based decoder, and the converting a second acoustic feature determined from the first acoustic feature into a third acoustic feature by the decoder, including: converting the second acoustic feature determined from the first acoustic feature into the third acoustic feature by the decoder through a reverse diffusion process.

The decoder is a diffusion-based decoder that can generate the speech through a reverse diffusion process. In other words, the speech generation model is a DPM which is capable of generating a high-quality speech with fast adaptation and small data requirements. In this way, a quality of the generated speech can be ensured in a model of the embodiments of the present application.

For example, the first acoustic feature can be a spectrogram-like feature corresponding to the first source data, and the third acoustic feature can be a spectrogram of the speech with a target voice. The spectrogram of the speech with the target voice can be called a target spectrogram. The spectrogram-like feature corresponding to the first source data can be anyone of the following: a spectrogram corresponding to the first source data, an acoustic feature corresponding to the first source data that can be aligned with the target spectrogram on a time axis, or concatenation of the spectrogram corresponding to the first source data and the acoustic feature corresponding to the first source data that can be aligned with the target spectrogram on the time axis.

For example, the first source data can be source audio data, source text data or source video data.

For example, the second acoustic feature can be the first acoustic feature.

For example, the third acoustic feature can be a target acoustic feature, such as a fine grained spectrogram.

In an embodiment, the multiple encoders include at least two of the following: a video encoder, a speech encoder and a text encoder where the first encoder is the speech encoder when the first source data is audio data, the first encoder is the text encoder when the first source data is text data, or the first encoder is the video encoder when the first source data is video data.

In an embodiment, the multiple encoders and the decoder are trained, respectively.

In an embodiment, the multiple encoders include a speech encoder and a text encoder, where the first encoder is the speech encoder when the first source data is audio data, or the first encoder is the text encoder when the first source data is text data.

The model consisting of the speech encoder, the text encoder and the decoder described above can perform both the voice cloning and the voice conversion: the speech encoder combined with the decoder is used to perform the voice conversion whereas the text encoder combined with the decoder corresponds to a voice cloning task.

In an embodiment, the first acoustic feature is an average spectrogram corresponding to the first source data.

The average spectrogram can be regarded as a speaker independent speech representation. The first encoder remain speaker independent, which means it does not need to be fine-tuned as for speaker adaptation.

In an embodiment, the speech encoder, the text encoder and the decoder are trained, respectively.

According to technical solutions provided by the embodiments of the present application, the two encoders and the decoder in the model can be trained respectively to avoid instability caused by a joint training. The two encoders can be trained respectively with the same target in a supervision manner, and such supervision manner is more reliable because outputs of the two encoders have a clear interpretation, such as the average voice spectrogram, and do not belong to a latent space.

In an embodiment, the method further includes: obtaining a second source data input to a speech generation model; and generating a fourth acoustic feature by a second encoder among the multiple encoders based on the second source data, where the type of the second source data is consistent with the type of the input data of the second encoder, and the second acoustic feature is obtained by concatenating the fourth acoustic feature and the first acoustic feature.

For example, the first encoder can be a speech encoder or a text encoder, and the second encoder can be a video encoder.

In an embodiment, the converting a second acoustic feature determined from the first acoustic feature into a third acoustic feature by the decoder through a reverse diffusion process includes: converting the second acoustic feature determined from the first acoustic feature into the third acoustic feature by the decoder through the reverse diffusion process conditioned on information about the target voice, where the information about the target voice is generated by a speaker encoder.

The speech generation model includes the speaker encoder, which can be used to copy the target voice. In this way, even in a scenario where there is no target voice data for training, that is, a zero-shot scenario, the speech with the target voice can be generated by the speech generation model provided by the embodiments of the present application.

According to a second aspect, an embodiment of the present application provides an electronic device, the electronic device has a function of implementing the method in the first aspect. The function may be implemented by a hardware, or may be implemented by the hardware executing the corresponding software. The hardware of the software includes one or more modules corresponding to the function.

According to a third aspect, an embodiment of the present application provides a computer readable storage medium having instructions which, when run on a computer, the computer is caused to perform the method in the first aspect or any possible implementation manner of the first aspect.

According to a fourth aspect, provided is an electronic device, including a processor and a memory. The processor is connected to the memory. The memory is configured to store instructions, the processor is configured to execute the instructions. When the processor executes the instructions stored in the memory, the processor is caused to perform the method in the first aspect or any possible implementation manner of the first aspect.

According to a fifth aspect, provided is a chip system, including a memory and a processor, where the memory is configured to store a computer program, and the processor is configured to invoke the computer program from the memory and run the computer program, so that a server on which a chip is disposed performs the method in the first aspect or any possible implementation manner of the first aspect.

According to a sixth aspect, provided is a computer program product which, when run on an electronic device, the electronic device is caused to perform the method in the first aspect or any possible implementation manner of the first aspect.

### DESCRIPTION OF DRAWINGS

FIG. 1 is a schematic block diagram of a speech generation model according to an embodiment of the present application.

FIG. 2 is a flowchart of an embodiment of voice conversion according to an embodiment of the present application.

FIG. 3 is a flowchart of an embodiment of voice cloning according to an embodiment of the present application.

FIG. 4 is a flowchart of an embodiment of speech generation according to an embodiment of the present application.

FIG. 5 is a flowchart of another embodiment of speech generation according to an embodiment of the present application.

FIG. 6 is a flowchart of yet another embodiment of speech generation according to an embodiment of the present application.

FIG. 7 is a flowchart of an embodiment of a method for speech generation.

FIG. 8 is a schematic block diagram of an electronic device 800 according to an embodiment of the present application.

FIG. 9 is a schematic block diagram of an electronic device 900 according to an embodiment of the present application.

### DESCRIPTION OF EMBODIMENTS

The following describes technical solutions of the present application with reference to the accompanying drawings.

In order to facilitate understanding of the embodiments of the present application, related terms involved in the embodiments of the present application are introduced below.

### (1) Voice Cloning

A voice cloning is a task usually formulated as adding a new voice to a TTS system. In other words, the voice cloning is essentially a TTS technology allowing to copy a voice of a target speaker.

When the target speaker data is available, the voice cloning may be performed by means of speaker adaptation. The speaker adaptation usually refers to fine-tuning the TTS system on a small amount of target speaker data to obtain a well-performing TTS for the target voice.

When only one short target voice sample is available, the voice cloning is performed by means of speaker encoding. The speaker encoding usually refers to using a pretrained or learnable speaker representation to help extract speaker identity information, such as timbre and tone, from a reference speech sample.

### (2) Voice Conversion

A voice conversion is a task of copying a target speaker's voice while preserving a linguistic content of utterance pronounced by a source speaker.

Any-to-one (A2O) voice conversion (VC) aims to convert any speaker, including those not seen during training, into a fixed target speaker.

In practice, it is preferable to have an any-to-voice conversion model. The any-to-any voice conversion model refers to a model capable of copying a target voice while preserving a source speech content when both source and target speakers do not necessarily belong to a training dataset.

### (3) Diffusion Probabilistic Model (DPM)

A DPM includes forward diffusion and reverse diffusion. The forward diffusion gradually adds Gaussian noise to data, while the reverse diffusion tries to remove this noise. The DPM is trained to minimize a distance between trajectories of forward and reverse diffusion processes. In other words, a training goal of the DPM is to find the reverse diffusion, such that its trajectory closely follows that of the forward diffusion but in a reverse time order.

Different speech generation tasks are usually solved by using different models. For example, TTS and voice conversion are two common speech generation tasks typically solved by using different models.

Embodiments of the present application provides a speech generation model capable of processing different types of input data to generate a speech. In other words, the speech generation model of the embodiments of the present application can solve multiple different speech generation tasks.

The speech generation model provided by the embodiments of the present application includes multiple encoders and a decoder shared by the multiple encoders. The output of the multiple encoders may be the input of the decoder.

FIG. 1 is a schematic block diagram of a speech generation model according to an embodiment of the present application. As shown in FIG. 1, a speech generation model 100 may include an encoder 111, an encoder 112 and a decoder 120.

It should be noted that FIG. 1 is only a schematic diagram of a speech generation model provided by the embodiments of the present application, and the number of encoders shown in FIG. 1 does not constitute any limitation. In FIG. 1, the speech generation model 100 includes two encoders, and in other cases, the speech generation model can also include more encoders.

Each encoder of the multiple encoders is used to obtain an acoustic feature corresponding to its own input data. The decoder is used to obtain a target acoustic feature conditioned on a target voice according to the output of at least one encoder. The target acoustic feature conditioned on the target voice can be used to generate the speech with the target voice. For example, an output domain of the decoder can be a spectrogram of the speech with the target voice. The spectrogram of the speech with the target voice can be called a target spectrogram. The output of the decoder can be converted into a waveform by a vocoder, such as universal generative adversarial networks for efficient and high fidelity speech synthesis (HiFi-GAN) vocoder. The vocoder may belong to the speech generation model, or the vocoder may not belong to the speech generation model.

For example, the multiple encoders can be implemented with neural networks.

Types of the multiple encoders are different. A type of input data of the multiple encoders is related to a type of the encoder. Correspondingly, the input data of the multiple encoders are different types of data. The input data of the multiple encoders can be called source data.

In an embodiment, the multiple encoders may include at least two of the following: a speech encoder, a text encoder or a video encoder.

The input data of the speech encoder may be acoustic data such as audio, speech or acoustic features. The acoustic features may be the spectrogram, or be called spectral features.

For example, the spectrogram may be a mel-spectrogram, in which case, the speech encoder may also be called a mel encoder, and the mel-spectrogram may also be called mel features.

The input data of the text encoder may be text data such as text, character or phoneme embedding.

The input data of the video encoder may be video data. For example, the video encoder may be a lip-reading encoder.

For example, the encoder 111 in FIG. 1 may be a speech encoder, and the encoder 112 in FIG. 1 may be a text encoder. For another example, the encoder 111 in FIG. 1 may be a speech encoder, and the encoder 112 in FIG. 1 may be a video encoder. For yet another example, the encoder 111 in FIG. 1 may be a text encoder, and the encoder 112 in FIG. 1 may be a video encoder.

Output domains of the multiple encoders can be the same or different.

In an embodiment, the encoder in the speech generation model is used to generate a spectrogram-like output.

For example, the spectrogram-like output can be the spectrogram. Or the spectrogram-like output can be an acoustic feature that can be aligned with the spectrogram on a time axis, such as pitch, loudness, and a spectrogram convolved with a certain filter bank along a frequency axis. Or the spectrogram-like output can be concatenation of the spectrogram and the acoustic feature that can be aligned with the spectrogram on the time axis.

In an embodiment, at least one encoder is used to generate the spectrogram in the speech generation model. In this case, the spectrogram generated by the encoder can be regarded as the acoustic feature corresponding to its own input data.

In an embodiment, the multiple encoders work collaboratively to generate the spectrogram in the speech generation model.

The above speech encoder, text encoder or video encoder can be used to generate the spectrogram. Or at least one encoder of the speech encoder, the text encoder or the video encoder can be used to generate the spectrogram.

It should be noted that the encoders are merely examples. As mentioned above, the output domain of the decoder can be the spectrogram, that is, the target spectrogram. In this case, the encoder should generate an output that can be aligned with the target spectrogram. The spectrogram-like output can be aligned with the target spectrogram. Therefore, other encoders capable of generating the spectrogram-like output can also be used as encoders in the embodiments of the present application.

Further, the output of the encoder can approximate to the target spectrogram roughly. For example, the output of the encoder can be one of the followings: an average spectrogram corresponding to input data of the encoder, a spectrogram of some voice, or a low resolution spectrogram of the target voice.

For ease of understanding and description, the embodiments of the present application take the average spectrogram as an example for description.

The average spectrogram can be called an average voice spectrogram. An average voice refers to pronunciation of each phoneme in such a way that its features may be the same as those averaged across a multi-speaker dataset. For example, the average voice spectrogram can be an average voice mel-spectrogram, which can be called an average phoneme-level mel feature.

For example, the encoder for predicting the average spectrogram corresponding to the input data can be obtained by training. In an embodiment, the encoder can be trained with a goal of reducing a difference between the output of the encoder and a ground-truth average spectrogram corresponding to training source data. During a training process of the encoder, the training source data is the input data of the encoder. A way to obtain the ground-truth average spectrogram can refer to an example in the following section.

In an inference process, the output of the encoder trained in the above way can be regarded as the average spectrogram corresponding to the input data of the encoder.

In the embodiments of the present application, the encoder can be used to predict the average spectrogram corresponding to the input data of the encoder.

For example, the speech encoder can be used to predict the average spectrogram corresponding to a source audio, the text encoder can be used to predict the average spectrogram corresponding to a source text, and the video encoder can be used to predict the average spectrogram corresponding to a source video.

The average spectrogram is independent of a speaker corresponding to the input data of the encoder, and the speaker corresponding to the input data of the encoder can be called a source speaker, thus the average spectrogram can be regarded as a speaker-independent speech representation.

In an embodiment, the multiple encoders and the decoder in the speech generation model can be trained, respectively.

Taking the model 100 in FIG. 1 as an example, encoder 111, encoder 112 and decoder 120 can be trained separately. In other words, encoder 111, encoder 112 and decoder 120 can be regarded as three separate modules. During the training of one of the three separate modules, the parameters of the other modules are fixed.

For example, the encoder 111 in FIG. 1 can be used to predict the average spectrogram corresponding to input data of the encoder 111, and the encoder 112 in FIG. 1 can be used to predict the average spectrogram corresponding to input data of the encoder 112. The following describes the training process of the encoder by taking the encoder 111 as a mel encoder and the encoder 112 as a text encoder as an example.

The mel encoder φ is trained to convert audio data X₀ into the average spectrogram corresponding to the audio data X₀.

For example, the mel encoder φ is trained to minimize a mean square error (MSE) between an output spectrogram X̅_{φ}=φ(X₀) and a ground truth average spectrogram X̅_{GT}, and at training, X₀ is training source audio data.

The training source audio data can be a training source spectrogram X₀. The ground truth average spectrogram X̅_{GT} can be obtained by replacing features corresponding to each phoneme in the training source spectrogram X₀ with ones corresponding to this particular phoneme aggregated across a corpus of speech data from multiple speakers. The corpus can be an existing corpus, or the corpus can also be a corpus set as required.

For example, there is a phoneme A in the training source spectrogram X₀. Features of the phoneme A in the training source spectrogram X₀ are replaced with the average features of the phoneme A. The average features of the phoneme A are obtained by aggregating the features of the phoneme A across the corpus of the speech data from the multiple speakers. The above operations for each phoneme in the training source spectrogram X₀ are performed to obtain the ground truth average spectrogram X̅_{GT} corresponding to the training source spectrogram X₀.

During the inference, X₀ is the source audio data to be processed, which is simply called the source audio data. An output X̅_{φ} of the mel encoder trained in the above way can be regarded as the average spectrogram corresponding to the source audio data X₀.

For example, a transformer-based architecture can be used as the speech encoder.

A text encoder ψ is trained to convert source text data T into the average spectrogram corresponding to the source text data T.

For example, the text encoder ψ is trained to minimize MSE between an output spectrogram X̅_{ψ}=ψ(T) and a ground truth average spectrogram X̅_{GT}. During the training, T is training source text data.

A method of obtaining the ground truth average spectrogram X̅_{GT} can be the same as above. That is to say, when a linguistic content of the training source text data T and the training source audio data X₀ are the same, the ground truth average spectrogram X̅_{GT} can be also the same, that is, a target output of the text encoder and a target output of the speech encoder are the same during the training.

The text encoder can be a text encoder of an existing structure, or can also be a self-configured text encoder.

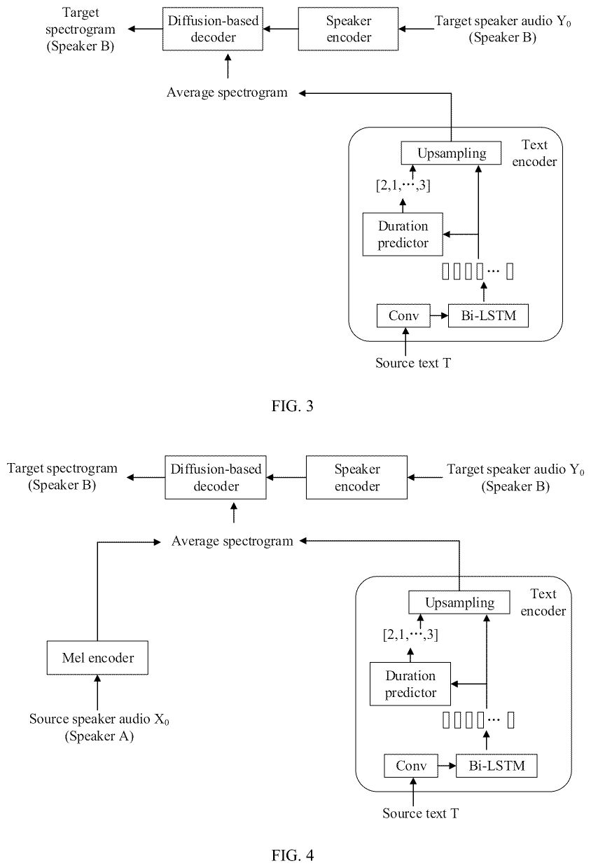

For example, the text encoder can be the encoder shown in FIG. 3. The text encoder converts an input text into an encoded text sequence, which is then mapped to frame-wise features, such as the spectrogram. As shown in FIG. 3, a convolutional layer (conv) and a Bi-directional long short term memory (Bi LSTM) are used to generate the encoded text sequence. And a duration predictor produces a monotonic alignment indicating how many frames each element of a text input lasts which can help generate the spectrogram. Upsampling is a procedure of repeating each output of Bi-LSTM that many times as it is predicted by the duration predictor to ensure a spectrogram having a correct duration can be generated.

In an embodiment, there is a speaker encoder in the speech generation model. The speaker encoder is used to provide information about the target voice for the decoder, in which case, the decoder generates the acoustic feature conditioned on the target voice. The decoder is a speaker-conditional decoder. For example, the decoder can be used to convert the average spectrogram into a fine-grained spectrogram conditioned on the information about the target voice.

For example, the information about the target voice can be speaker embedding.

The speaker encoder can be jointly trained with the decoder, so the speaker encoder can also be considered to be a part of the decoder.

The speaker encoder can be called speaker encoding network.

The decoder can be a diffusion-based decoder. The speech generation model in the embodiments of the present application can be regarded as a DPM trying to convert the acoustic feature extracted from source data by means of at least one encoder among the multiple encoders into the target acoustic feature by employing speaker dependent score matching network which is called the decoder.

A forward diffusion transforms any source data into a normal random variable X₁˜N(X̅,I), where I is an identity matrix and X̅ is predicted by at least one encoder.

For example, the source data can be a source spectrogram X₀. X̅=φ(X₀) can be an average voice spectrogram predicted by the mel encoder φ. Thus, the prior N(X̅, I) in this DPM is a speaker independent speech representation preserving the linguistic content of the source data.

A reverse diffusion parameterized by the decoder is trained to approximate a forward diffusion trajectory backwards in a time variable t∈[0,1].

As mentioned, the decoder and the multiple encoders can be trained, respectively.

Whereas the encoder parameterizes a terminal distribution of the forward diffusion (i.e., the prior), the reverse diffusion is parameterized with the decoder.

For example, once the mel encoder φ parameterizing the DPM prior N(X̅,I) is trained, parameters of the mel encoder φ are fixed and the decoder corresponding to the reverse diffusion starts to be trained.

As an embodiment, the DPM can be formalized by employing a stochastic differential equation (SDE).

Forward X and reverse \hat{X} diffusion processes may be obtained by the following SDEs:

$${dX}_{t} = \frac{1}{2} {β}_{t} ( \overline{X} - {X}_{t} ) dt + \sqrt{{β}_{t}} d {\vec{W}}_{t} , \qquad ( formula 1.1 )$$

$$d {\hat{X}}_{t} = ( \frac{1}{2} ( \overline{X} - {\hat{X}}_{t} ) - {s}_{θ}^{Y} ( {\hat{X}}_{t} , \overline{X} , t ) ) {β}_{t} dt + \sqrt{{β}_{t}} d {\overleftarrow{W}}_{t} , \qquad ( formula 1.2 )$$

Among them, t∈[0,1], [symbol] and \vec{W} are forward and reverse standard Brownian Motions independent of each other correspondingly. βₜ is a non-negative noise schedule. Xₜ is a sample in the forward diffusion. \hat{X}ₜ is a sample in the reverse diffusion.

Speaker conditioning in the decoder is enabled by the speaker encoding network gₜ(Y).

The reverse SDE (formula 1.2) is conditioned on the target voice through a speaker encoding network gₜ(Y) integrated into a score matching network s_{θ} and trained jointly with it:

$${s}_{θ}^{Y} ( {\hat{X}}_{t} , \overline{X} , t ) = {s}_{θ} ( {\hat{X}}_{t} , \overline{X} , {g}_{t} ( Y ) , t ) , \qquad ( formula 1.3 )$$

Among them, the decoder parameters are denoted by θ, and Y={Yₛ}_{s∈[0,1]} is a whole trajectory of a reference spectrogram Y₀ computed for the target voice under the forward diffusion. In other words, Y={Yₛ}_{s∈[0,1]} is a whole forward diffusion trajectory starting at Y₀. The reference spectrogram Y₀ can be a training spectrogram during the training, that is, the training source spectrogram X₀. The reference spectrogram Y₀ can be the spectrogram of the target voice during the inference.

A well-trained decoder enables generative modeling by sampling \hat{X}₁ from the prior N(X̅,I) and simulating paths of the reverse diffusion parameterized with this decoder on a unit time interval [0,1]. A resulting sample \hat{X}₀ at an initial time point is an output of a speech generation task.

The speaker embedding is also re-estimated at each iteration of the reverse diffusion process during the inference and fed back to a gradient prediction network of the decoder.

The decoder can be implemented with the neural network. For example, the decoder has a UNet-based architecture.

The speaker encoding network gₜ(Y) can be composed of 2D convolutions and multilayer perceptron (MLP).

It should be noted that the DPM can also be formalized in other ways. For example, the DPM can also be formalized by employing a Markov chain, which is not limited in the embodiments of the present application.

The speech generation model in the embodiments of the present application has the multiple encoders and a shared decoder, where the multiple encoders can operate on different input domains, respectively, so that a whole model performs corresponding different speech generation tasks. In other word, solutions of the embodiments of the present application can generate the speech based on different types of input data by one model.

And the decoder is a diffusion-based decoder that can generate the speech through a reverse diffusion process. In other words, the speech generation model is the DPM capable of generating a high-quality speech with fast adaptation and small data requirements. In this way, a quality of the generated speech can be ensured in a model of the embodiments of the present application.

According to technical solutions provided by the embodiments of the present application, the two encoders and the decoder in the model can be trained respectively to avoid instability caused by a joint training. The two encoders can be trained respectively with the same target in a supervision manner, and such supervision manner is more reliable because outputs of the two encoders have a clear interpretation, such as the average voice spectrogram, and do not belong to a latent space. And as for the speaker adaptation, it is only the decoder that has to be fine-tuned while the two encoders remain speaker-independent.

In addition, the speech generation model includes the speaker encoder, the speaker encoder can be used to copy the target voice. In this way, even in a scenario where there is no target voice data for training, that is, a zero-shot scenario, the speech with the target voice can be generated by the speech generation model provided by the embodiments of the present application.

The model in the embodiments of the present application can be in different modes when performing different speech generation tasks. In other words, the model can perform different speech generation tasks based on different modes. In different modes, the encoders involved in performing tasks may be different.

For example, the multiple encoders may include the speech encoder, in which the model can be used to perform a voice conversion. When the model is in a voice conversion mode, the speech encoder combined with the decoder is used to perform the voice conversion.

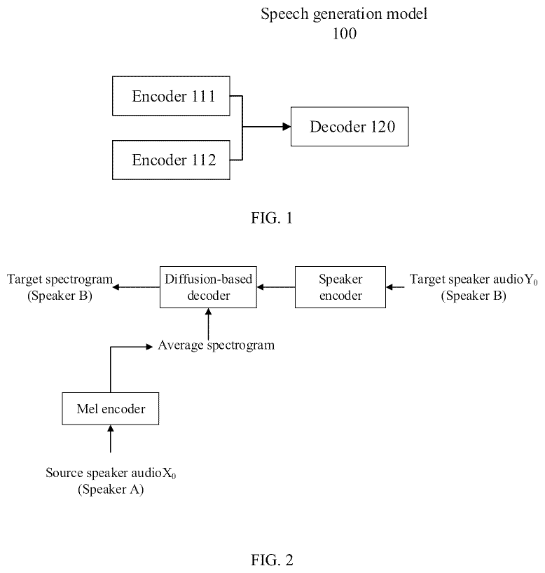

FIG. 2 is a flowchart of an embodiment of a voice conversion according to an embodiment of the present application.

The type of the source data is audio data, which corresponds to the speech encoder, that is, the mel encoder in FIG. 2. The mel encoder predicts the average spectrogram corresponding to a source speaker audio X₀ based on the source speaker audio. A voice in the source speaker audio belongs to a speaker A. The diffusion-based decoder conditioned on the information about the target voice generates the fine-grained spectrogram based on the average spectrogram. The information about the target voice can be obtained by processing a target speaker audio Y₀ through the speaker encoder. A voice in the target speaker audio is a speaker B in FIG. 2. A target speaker is the speaker B in FIG. 2. The fine-grained spectrogram can be converted into the speech with the target voice, that is, the voice of the speaker B. The fine-grained spectrogram can be regarded as the target acoustic feature, that is, the target spectrogram \hat{X}₀ in FIG. 2.

It should be noted that although FIG. 2 only shows one encoder, this does not mean that the model only has one encoder. The encoder shown in FIG. 2 is only for illustrating the encoder for data processing in a voice conversion mode.

For another example, the multiple encoders may include the text encoder, in which case, the model can be used to perform a voice cloning. When the model is in a voice cloning mode, the text encoder combined with the decoder is used to perform the voice cloning.

FIG. 3 is a flowchart of an embodiment of a voice cloning according to an embodiment of the present application.

The type of the source data is text data, which corresponds to the text encoder in FIG. 3. The text encoder predicts the average spectrogram corresponding to a source text T based on the source text T. The diffusion-based decoder conditioned on the information about the target voice generates the fine-grained spectrogram based on the average spectrogram. The information about the target voice can be obtained by processing the target speaker audio Y₀ through the speaker encoder. The voice in the target speaker audio Y₀ belongs to the speaker B. The target speaker is the speaker B in FIG. 3. The fine-grained spectrogram can be converted into the speech with the target voice, that is, the voice of the speaker B. The fine-grained spectrogram can be regarded as the target acoustic feature, that is, the target spectrogram \hat{X}₀ in FIG. 3.

It should be noted that although FIG. 3 only show one encoder, this does not mean that the model only has one encoder. The encoder shown in FIG. 3 is only for illustrating the encoder for data processing in the voice cloning mode.

For another example, the multiple encoders may include the speech encoder and the text encoder, in which case, the model can be used to generate the speech based on input audio data and input text data.

FIG. 4 is a flowchart of an embodiment of speech generation according to an embodiment of the present application.

The source data includes the audio data and the text data corresponding to the audio data, which respectively corresponds to the mel encoder and the text encoder in FIG. 4. The mel encoder predicts the average spectrogram corresponding to the source speaker audio X₀ based on the source speaker audio X₀. The voice in the source speaker audio X₀ belongs to the speaker A. The text encoder predicts the average spectrogram corresponding to the source text T based on the source text T. The diffusion-based decoder conditioned on the information about the target voice generates the fine-grained spectrogram based on the average spectrogram, which is determined according to an output of the mel encoder and an output of the text encoder. For example, the average spectrogram as an input of the decoder can be either the average spectrogram corresponding to the source speaker audio X₀ or the average spectrogram corresponding to the source text T. The information about the target voice can be obtained by processing the target speaker audio Y₀ through the speaker encoder. The voice in the target speaker audio Y belongs to the speaker B. The target speaker is the speaker B in FIG. 4. The fine-grained spectrogram can be converted into the speech with the target voice, that is, the voice of the speaker B. The fine-grained spectrogram can be regarded as the target acoustic feature, that is, the target spectrogram \hat{X}₀ in FIG. 4.

It should be noted that although FIG. 4 only show two encoders, this does not mean that the model only has two encoders.

For another example, the multiple encoders may include a lip-reading video encoder, in which case, the model can be used to generate the speech based on an input video.

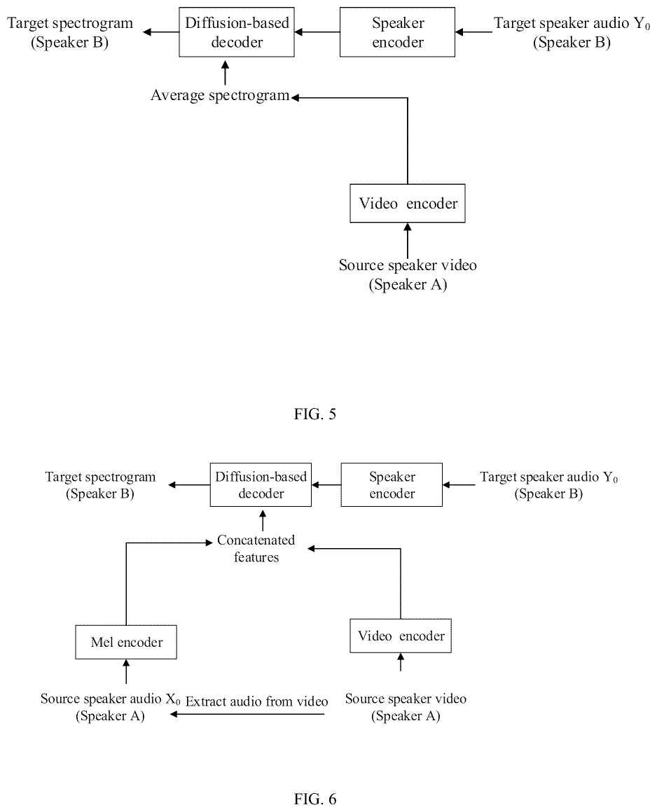

FIG. 5 is a flowchart of an embodiment of speech generation according to an embodiment of the present application.

The type of the source data is video data, which corresponds to the lip-reading video encoder in FIG. 5. The lip-reading video encoder predicts the average spectrogram corresponding to the source video based on the source video. The voice in the source video belongs to the speaker A. The diffusion-based decoder conditioned on the information about the target voice generates the fine-grained spectrogram based on the average spectrogram. The information about the target voice can be obtained by processing the target speaker audio Y₀ through the speaker encoder. The voice in the target speaker audio Y₀ belongs to the speaker B. The target speaker is the speaker B in FIG. 5. The fine-grained spectrogram can be converted into the speech with the target voice, that is, the voice of the speaker B. The fine-grained spectrogram can be regarded as the target acoustic feature, that is, the target spectrogram \hat{X}₀ in FIG. 5.

It should be noted that although FIG. 5 only show one encoder, this does not mean that the model only has one encoder.

For another example, the multiple encoders may include the video encoder and the speech encoder, in which case, the model can be used to generate the speech based on the input video and an input audio.

FIG. 6 is a flowchart of an embodiment of speech generation according to an embodiment of the present application.

The type of the source data includes the video data and the audio data corresponding to the video data, which respectively correspond to the video encoder and the mel encoder in FIG. 6. The source speaker audio X₀ can be extracted from the source video. The mel encoder predicts the average spectrogram corresponding to the source speaker audio X₀ based on the source speaker audio X₀. The voice in the source speaker audio X₀ belongs to the speaker A. The video encoder generates video embedding based on the source video. For example, the video embedding can be used for emotion recognition. The diffusion-based decoder conditioned on the information about the target voice generates the fine-grained spectrogram based on concatenated features. For example, the concatenated features can be obtained by concatenating the average spectrogram and the video embedding. The information about the target voice can be obtained by processing the target speaker audio Y₀ through the speaker encoder. The voice in the target speaker audio Y belongs to the speaker B. The target speaker is the speaker B in FIG. 6. The fine-grained spectrogram can be converted into the speech with the target voice, that is, the voice of the speaker B. The fine-grained spectrogram can be regarded as the target acoustic feature, that is, the target spectrogram \hat{X}₀ in FIG. 6.

It should be noted that although FIG. 6 only show two encoders, this does not mean that the model only has two encoders.

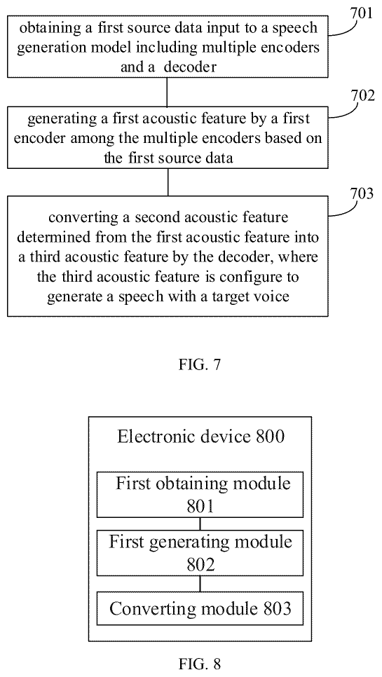

FIG. 7 is a flowchart of an embodiment of a method for speech generation. The method shown in FIG. 7 may be performed by a device or a device capable of performing a model operation. For example, the device can be a cloud service device or a terminal device, such as a computer, a server, or other devices with sufficient computing power to perform a data processing method. Or the device can be a system composed of the cloud service device and the terminal device.

The method shown in FIG. 7 includes the following operations:
701, obtaining a first source data input to a speech generation model including multiple encoders and a decoder, where types of input data of the multiple encoders are different;
702, generating a first acoustic feature by a first encoder among the multiple encoders based on the first source data, where the type of the first source data is consistent with the type of the input data of the first encoder;
703, converting a second acoustic feature determined from the first acoustic feature into a third acoustic feature by the decoder, where the third acoustic feature is configured to generate a speech with a target voice.

In an embodiment, the decoder can be a diffusion-based decoder. The converting a second acoustic feature determined from the first acoustic feature into a third acoustic feature by the decoder can include: converting the second acoustic feature determined from the first acoustic feature into the third acoustic feature by the decoder through a reverse diffusion process.

For example, the first source data can be the source audio data, the source text data or the source video data.

The speech generation can be the model in FIG. 1.

In an embodiment, the multiple encoders include at least two of the following: the video encoder, the speech encoder or the text encoder, where the first encoder is the speech encoder when the first source data is audio data, the first encoder is the text encoder when the first source data is text data, or the first encoder is the video encoder when the first source data is video data.

For example, the first acoustic feature can be a spectrogram-like feature corresponding to the first source data, and the third acoustic feature can be a spectrogram of the speech with the target voice. The spectrogram of the speech with the target voice can be called the target spectrogram. The spectrogram-like feature corresponding to the first source data can be anyone of the following: a spectrogram corresponding to the first source data, an acoustic feature corresponding to the first source data that can be aligned with the target spectrogram on a time axis, or concatenation of the spectrogram corresponding to the first source data and the acoustic feature that can be aligned with the target spectrogram on the time axis.

For example, the second acoustic feature can be the first acoustic feature.

For example, the third acoustic can be the target acoustic feature, such as the fine-grained spectrogram.

For example, the third acoustic feature can be converted into the speech with the target voice by the vocoder.

The speech generation model in the embodiments of the present application has the multiple encoders and the shared decoder, where the multiple encoders can operate on different input domains, respectively, so that the whole model performs corresponding different speech generation tasks. In other word, the solutions of the embodiments of the present application can generate the speech based on different types of the input data by one model.

And the decoder is the diffusion-based decoder that can generate the speech through the reverse diffusion process. In other words, the speech generation model is the DPM capable of generating the high-quality speech with the fast adaptation and the small data requirements. In this way, the quality of the generated speech can be ensured in the model of the embodiments of the present application.

In an embodiment, the multiple encoders and the decoder are trained, respectively.

In an embodiment, the multiple encoders include a speech encoder and a text encoder. The first encoder is the speech encoder when the first source data is the audio data, and the first encoder is the text encoder when the first source data is the text data.

The model consisting of the speech encoder, the text encoder and the decoder described above can perform both voice cloning and voice conversion: the speech encoder combined with the decoder is used to perform the voice conversion whereas the text encoder combined with the decoder corresponds to a voice cloning task.

In addition, due to a hybrid nature of the speech encoder and the text encoder, the speaker adaptation can be performed on untranscribed data.

In an embodiment, the first acoustic feature is the average spectrogram corresponding to the first source data.

The average spectrogram can be regarded as the speaker-independent speech representation. The first encoder remains speaker-independent, which means it does not need to be fine-tuned as for the speaker adaptation. If the multiple encoders remain speaker-independent, it is only the decoder that has to be fine-tuned as for the speaker adaptation.

For example, when the first source data is the audio data, the speech encoder can generate the average spectrogram corresponding to the audio data. When the first source data is the text data, the text encoder can generate the average spectrogram corresponding to the audio data.

In this way, the model can convert speaker-independent acoustic features, such as an average spectrogram extracted either from the text data by means of the text encoder or from the audio data by means of the speech encoder, into target acoustic features by the decoder.

In an embodiment, the speech encoder, the text encoder and the decoder are trained, respectively.

According to the technical solutions provided by the embodiments of the present application, the two encoders and the decoder in the model can be trained respectively to avoid the instability caused by the joint training. The two encoders can be trained respectively with the same target in the supervision manner, and such supervision manner is more reliable because the outputs of the two encoders have the clear interpretation, such as the average voice spectrogram, and do not belong to the latent space. And as for the speaker adaptation, it is only the decoder that has to be fine-tuned while the two encoders remain speaker-independent.

In an embodiment, the method further may include the following operations (not shown in the figure):
704, obtaining a second source data input to a speech generation model;
705, generating a fourth acoustic feature by a second encoder among the multiple encoders based on the second source data, where the type of the second source data is consistent with the type of the input data of the second encoder, and the second acoustic feature is obtained by concatenating the fourth acoustic feature and the first acoustic feature.

The type of the second source data and the type of the first source data can be different, in which case, the second encoder and the first encoder are different. In other words, different types of input data can be processed by different encoders in the model.

For example, the first acoustic feature can be the average spectrogram corresponding to the first source data. The second acoustic feature can be the video embedding generated by the video encoder (i.e., the second encoder).

It should be noted that operation numbers in the above method are only used for description and convenience, but do not limit an execution order of the operations.

In an embodiment, operation 703 includes: converting a second acoustic feature determined from the first acoustic feature into a third acoustic feature by the decoder through a reverse diffusion process conditioned on information about the target voice, where the information about the target voice is generated by a speaker encoder.

The speaker encoder could be considered as a part of the decoder since it is trained jointly with it.

The speech generation model includes the speaker encoder, which can be used to copy the target voice. In this way, even in a scenario where there is no target voice data for training, that is, a zero-shot scenario, the speech with the target voice can be generated by the speech generation model provided by the embodiments of the present application.

FIG. 8 is a schematic block diagram of an electronic device 800 according to the embodiments of the present application. As shown in FIG. 8, the electronic device 800 includes: a first obtaining module 801, a first generating module 802 and a converting module 803.

The first obtaining module 801 is configured to obtain a first source data input to a speech generation model including multiple encoders and a decoder, where types of input data of the multiple encoders are different.

The first generating module 802 is configured to generate a first acoustic feature by a first encoder among the multiple encoders based on the first source data, where the type of the first source data is consistent with the type of the input data of the first encoder.

The converting module 803 is configured to convert a second acoustic feature determined from the first acoustic feature into a third acoustic feature by the decoder, where the third acoustic feature is configured to generate a speech with a target voice.

In an embodiment, the decoder is a diffusion-based decoder, and the converting module is configured to: convert the second acoustic feature determined from the first acoustic feature into the third acoustic feature by the decoder through a reverse diffusion process.

In an embodiment, the multiple encoders include at least two of the following: a speech encoder, a text encoder or a video encoder. The first encoder is the speech encoder when the first source data is audio data, the first encoder is the text encoder when the first source data is text data, or the first encoder is the video encoder when the first source data is video data.

In an embodiment, the speech encoder, the multiple encoders and the decoder are trained, respectively.

In an embodiment, the third acoustic feature is a target spectrogram and the first acoustic feature is a spectrogram-like feature corresponding to the first source data, and the spectrogram-like feature corresponding to the first source data is anyone of the following: a spectrogram corresponding to the first source data, an acoustic feature corresponding to the first source data that is aligned with the target spectrogram on a time axis, or concatenation of the spectrogram corresponding to the first source data and the acoustic feature corresponding to the first source data that is aligned with the target spectrogram on the time axis.

In an embodiment, the first acoustic feature is an average spectrogram corresponding to the first source data.

In an embodiment, the electronic device further includes a second obtaining module and a second generating module (not shown in FIG. 8).

The second obtaining module is configured to obtain a second source data input to a speech generation model.

The second generating module is configured to generate a fourth acoustic feature by a second encoder among the multiple encoders based on the second source data, where the type of the second source data is consistent with the type of the input data of the second encoder, and the second acoustic feature is obtained by concatenating the fourth acoustic feature and the first acoustic feature.

In an embodiment, the converting module is configured to convert a second acoustic feature determined from the first acoustic feature into a third acoustic feature by the decoder through a reverse diffusion process conditioned on the information about the target voice, where the information about the target voice is generated by a speaker encoder.

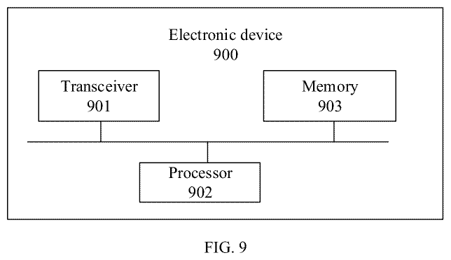

FIG. 9 is a schematic block diagram of an electronic device 900 according to the embodiments of the present application.

As shown in FIG. 9, the electronic device 900 may include a transceiver 901, a processor 902, and a memory 903. The memory 903 may be configured to store code, instructions, and the like executed by the processor 902.

It should be understood that the processor 902 may be an integrated circuit chip and has a signal processing capability. In an implementation process, operations of the foregoing method embodiments may be completed by using a hardware integrated logic circuit in the processor, or by using instructions in a form of software. The processor may be a general purpose processor, a digital signal processor (DSP), an application-specific integrated circuit (ASIC), a field programmable gate array (FPGA) or another programmable logic device, a discrete gate or transistor logic device, or a discrete hardware component. The processor may implement or perform the methods, the operations, and the logical block diagrams that are disclosed in the embodiments of the present disclosure. The general purpose processor may be a microprocessor, or the processor may be any conventional processor or the like. The operations of the methods disclosed with reference to the embodiments of the present disclosure may be directly performed and completed by a hardware decoding processor, or may be performed and completed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the operations of the foregoing methods in combination with hardware in the processor.

It may be understood that the memory 903 in the embodiments of the present disclosure may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM) and is used as an external cache. By way of example rather than limitation, many forms of RAMs may be used, and are, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchronous link DRAM, SLDRAM), and a direct rambus random access memory (Direct Rambus RAM, DR RAM).

It should be noted that the memory in the systems and the methods described in this specification includes but is not limited to these memories and a memory of any other appropriate type.

An embodiment of the present application further provides a system chip, where the system chip includes an input/output interface, at least one processor, at least one memory, and a bus. The at least one memory is configured to store instructions, and the at least one processor is configured to invoke the instructions of the at least one memory to perform operations in the methods in the foregoing embodiments.

An embodiment of the present application further provides a computer storage medium, where the computer storage medium may store a program instruction for performing any of the foregoing methods.

In an embodiment, the storage medium may be the memory 903.

One of ordinary skilled in the art may be aware that, in combination with the examples described in the embodiments disclosed in this specification, units and algorithm steps can be implemented by an electronic hardware or a combination of a computer software and the electronic hardware. Whether functions are performed by a hardware or a software depends on particular applications and design constraints of the technical solutions. One of ordinary skilled in the art may use different methods to implement the described functions for each particular application, but it should not be considered that the implementation goes beyond the scope of the present application.

It may be clearly understood by one of ordinary skilled in the art that, for a purpose of a convenient and brief description, for a detailed working process of the foregoing system, apparatus, and unit, refer to a corresponding process in the foregoing method embodiment. Details are not described herein again.

In the several embodiments provided in the present application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may be or may not be physically separate, and parts displayed as units may be or may not be physical units, may be located in one position, or may be distributed on a plurality of network units. Some or all of the units may be selected based on actual requirements to achieve objectives of the solutions of the embodiments.

In addition, functional units in the embodiments of the present application may be integrated into one processing unit, or each of the units may exist alone physically, or two or more units are integrated into one unit.

When the functions are implemented in a form of a software functional unit and sold or used as an independent product, the functions may be stored in a computer readable storage medium. Based on such an understanding, the technical solutions in the present application essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of the present application. The foregoing storage medium includes: any medium that can store program code, such as a USB flash drive, a removable hard disk, a read-only memory (ROM), a random access memory (RAM), a magnetic disk, or an optical disc.

The foregoing descriptions are merely implementations of the present application, but are not intended to limit a protection scope of the present application. Any variation or replacement readily figured out by one or ordinary skilled in the art within the technical scope disclosed in the present application shall fall within the protection scope of the present application. Therefore, the protection scope of the present application shall be subject to the protection scope of the claims.

1. A method for speech generation, comprising:
obtaining a first source data input to a speech generation model comprising multiple encoders and a decoder, wherein types of input data of the multiple encoders are different;
generating a first acoustic feature by a first encoder among the multiple encoders based on the first source data, wherein a type of the first source data is consistent with the type of the input data of the first encoder; and
converting a second acoustic feature determined from the first acoustic feature into a third acoustic feature by the decoder, wherein the third acoustic feature is configured to generate a speech with a target voice.

2. The method according to claim 1, wherein the decoder is a diffusion-based decoder, and wherein the converting the second acoustic feature determined from the first acoustic feature into the third acoustic feature by the decoder comprises:
converting the second acoustic feature determined from the first acoustic feature into the third acoustic feature by the decoder through a reverse diffusion process.

3. The method according to claim 1, wherein the multiple encoders comprise at least two of: a speech encoder, a text encoder, or a video encoder, wherein the first encoder is the speech encoder when the first source data is audio data, the first encoder is the text encoder when the first source data is text data, or the first encoder is the video encoder when the first source data is video data.

4. The method according to claim 1, wherein the multiple encoders and the decoder are trained, respectively.

5. The method according to claim 1, wherein the third acoustic feature is a target spectrogram and the first acoustic feature is a spectrogram-like feature corresponding to the first source data, and the spectrogram-like feature corresponding to the first source data is anyone of: a spectrogram corresponding to the first source data, an acoustic feature corresponding to the first source data aligned with the target spectrogram on a time axis, or concatenation of the spectrogram corresponding to the first source data and the acoustic feature corresponding to the first source data aligned with the target spectrogram on the time axis.

6. The method according to claim 5, wherein the first acoustic feature is an average spectrogram corresponding to the first source data.

7. The method according to claim 1, further comprising:
obtaining a second source data input to a speech generation model; and
generating a fourth acoustic feature by a second encoder among the multiple encoders based on the second source data, wherein the type of the second source data is consistent with the type of the input data of the second encoder, and the second acoustic feature is obtained by concatenating the fourth acoustic feature and the first acoustic feature.

8. The method according to claim 1, wherein the converting the second acoustic feature determined from the first acoustic feature into the third acoustic feature by the decoder comprises:
converting the second acoustic feature determined from the first acoustic feature into the third acoustic feature by the decoder through a reverse diffusion process conditioned on information about the target voice, wherein the information about the target voice is generated by a speaker encoder.

9. An electronic device, comprising:
a processor,
a communications interface configured to receive or send data, and
a memory coupled to the processor to store instructions, which when executed by the processor, cause the processor to perform operations, the operations comprising:
obtaining a first source data input to a speech generation model comprising multiple encoders and a decoder, wherein types of input data of the multiple encoders are different;
generating a first acoustic feature by a first encoder among the multiple encoders based on the first source data, wherein a type of the first source data is consistent with the type of the input data of the first encoder; and
converting a second acoustic feature determined from the first acoustic feature into a third acoustic feature by the decoder, wherein the third acoustic feature is configured to generate a speech with a target voice.

10. The electronic device according to claim 9, wherein the decoder is a diffusion-based decoder, and wherein the operations further comprise:
converting the second acoustic feature determined from the first acoustic feature into the third acoustic feature by the decoder through a reverse diffusion process.

11. The electronic device according to claim 9, wherein the multiple encoders comprise at least two of: a speech encoder, a text encoder, or a video encoder, wherein the first encoder is the speech encoder when the first source data is audio data, the first encoder is the text encoder when the first source data is text data, or the first encoder is the video encoder when the first source data is video data.

12. The electronic device according to claim 9, wherein the multiple encoders and the decoder are trained, respectively.

13. The electronic device according to claim 9, wherein the third acoustic feature is a target spectrogram and the first acoustic feature is a spectrogram-like feature corresponding to the first source data, and the spectrogram-like feature corresponding to the first source data is anyone of: a spectrogram corresponding to the first source data, an acoustic feature corresponding to the first source data aligned with the target spectrogram on a time axis, or concatenation of the spectrogram corresponding to the first source data and the acoustic feature corresponding to the first source data aligned with the target spectrogram on the time axis.

14. The electronic device according to claim 13, wherein the first acoustic feature is an average spectrogram corresponding to the first source data.

15. The electronic device according to claim 9, the operations further comprising:
obtaining a second source data input to a speech generation model; and
generating a fourth acoustic feature by a second encoder among the multiple encoders based on the second source data, wherein the type of the second source data is consistent with the type of the input data of the second encoder, and the second acoustic feature is obtained by concatenating the fourth acoustic feature and the first acoustic feature.

16. The electronic device according to claim 9, the operations further comprising:
converting the second acoustic feature determined from the first acoustic feature into the third acoustic feature by the decoder through a reverse diffusion process conditioned on information about the target voice, wherein the information about the target voice is generated by a speaker encoder.

17. A non-transitory machine readable storage medium having instructions stored therein, which when executed by a processor, cause the processor to perform operations, the operations comprising:
obtaining a first source data input to a speech generation model comprising multiple encoders and a decoder, wherein types of input data of the multiple encoders are different;
generating a first acoustic feature by a first encoder among the multiple encoders based on the first source data, wherein the type of the first source data is consistent with the type of the input data of the first encoder; and
converting a second acoustic feature determined from the first acoustic feature into a third acoustic feature by the decoder, wherein the third acoustic feature is configured to generate a speech with a target voice.

18. The non-transitory machine-readable storage medium according to claim 17, wherein the decoder is a diffusion-based decoder, and wherein the operations further comprise:
converting the second acoustic feature determined from the first acoustic feature into the third acoustic feature by the decoder through a reverse diffusion process.

19. The non-transitory machine-readable storage medium according to claim 17, wherein the multiple encoders comprise at least two of: a speech encoder, a text encoder, or a video encoder, wherein the first encoder is the speech encoder when the first source data is audio data, the first encoder is the text encoder when the first source data is text data, or the first encoder is the video encoder when the first source data is video data.

20. The non-transitory machine-readable storage medium according to claim 17, wherein the multiple encoders and the decoder are trained, respectively.
